(19) United States
(12) Patent Application Publication
(10) Pub. No.: US 2018/0275071 A1
(43) Pub. Date: Sep. 27, 2018

(54) SLOT DIE COATING DEVICE AND CONTROL METHOD THEREFOR

(71) Applicant: SUNG AN MACHINERY CO., LTD., Hwaseong-si Gyeonggi-do (KR)

(72) Inventors: Dong Kwon CHOI, Gunpo-si Gyeonggi-do (KR); Ok Jin KIM, Hwaseong-si Gyeonggi-do (KR); Young Min LEE, Gunpo-si Gyeonggi-do (KR); Young Jin KIM, Suwon-si Gyeonggido (KR)

(73) Assignee: SUNG AN MACHINERY CO., LTD., Hwaseong-si Gyeonggi-do (KR)

(21) Appl. No.: 15/762,177

(22) PCT Filed: Sep. 23, 2016
(86) PCT No.: PCT/KR2016/010608

§ 371 Date: Mar. 22, 2018

(30) Foreign Application Priority Data
Sep. 24, 2015 (KR) 10-2015-0135309

(51) Int. Cl. G01N 21/84; B05C 5/02; B05C 11/00

(52) U.S. Cl. CPC G01N 21/84; B05C 5/0254; G01N 2021/8416; G01N 21/8422; G01N 2021/8427; B05C 11/00

(57) ABSTRACT

The present invention relates to a slot die coating device and a control method therefor. The slot die coating device according to one embodiment of the present invention comprises: a slot die for performing a coating process by coating a substrate with ink; an image capturing unit located adjacent to the slot die, and photographing a state of the slot die and a state of the ink coated on the substrate during the coating process; and a control unit for controlling an operation of the slot die according to a result of the comparison between an image captured by the image capturing unit and a reference image, wherein the slot die comprises: a first body having a cavity in which the ink supplied from the outside is accommodated; a second body arranged so as to be spaced apart from the first body; and a shim plate coupled between the first body and the second body, having an outlet communicating with the cavity so as to discharge the ink accommodated in the cavity, and having at least one protrusion part exposed to the outside of the first body and the second body, wherein the control unit sets the reference image on the basis of the at least one protrusion part and compares the image captured by the image capturing unit and the reference image.

### TECHNICAL FIELD

The present invention relates to a slot die coating device and a control method there for and, more particularly, to a slot die coating device and a control method for the same with advantages of real-time monitoring a state of the slot die and a state of ink applied to a substrate and thinly and uniformly applying the ink to the substrate.

### BACKGROUND ART

Recently, printed electronics technology, wherein diverse patterns are printed and formed on a variety of substrates with functional ink (hereinafter, commonly referred to as ‘ink’) so as to manufacture electronic devices, has received attention.

Such printed electronics technology has an advantage of utilizing simpler working processes, compared to conventional photolithography techniques used for forming patterns on a substrate. Further, a roll-to-roll printing device for printing with a functional ink on a roll type film or web supplied continuously is further increasing production efficiency because of high production rate owing to the continuous process.

In general, the roll-to-roll printing device conducts a coating process of applying ink to a film in order to perform the printing process on the film. Such a coating process may be conducted by means of gravure, rotary screening, slot die, and the like. There among, the coating method using a slot die has advantages such as coating of a wide width, no change of ink viscosity and no introduction of impurities, and excellent reproduction of ink coating.

Meanwhile, in order to manufacture electronic devices by the printed electronics technology that performs ink-printing on a substrate, print accuracy is very significant and the electronic device usually requires a print accuracy of several μm to several tens of μm, depending upon types of objects to be printed.

Generally, a slot die coating device for conducting a coating process in a slot die mode should thinly and uniformly coat a substrate with an ink, in order to increase print accuracy of printed electronics. For this purpose, according to coating conditions such as types of a substrate, a transfer speed of the substrate, etc., it is important to not only adjust an interval between the slot die and the substrate but also to quantitatively control the ink discharged from the slot die (ink supplied to the slot die) so as to form an ink thin film coating having desired thickness.

However, a conventional slot die coating device does not have any means for real-time monitoring and control of a state of the substrate to be coated, and therefore, an amount of ink supply is adjusted while temporarily stopping the coating process, or an interval between the slot die and the substrate is adjusted using a control gauge mounted on the slot die. Due to this, the conventional slot die coating device could not respond to variation in different processing conditions during the coating process of the substrate, thus entailing a problem of not achieving uniform application of ink.

Accordingly, there is currently demand for a novel slot die coating device which may conduct real-time monitoring of a state of a slot die and a state of ink applied to a substrate and may thinly and uniformly coat the substrate with the ink, as well as a control method for the same.

### DISCLOSURE

### Technical Problem

The present invention has been developed to solve the problems mentioned above. Therefore, an object of the present invention is to provide a slot die coating device which captures images of a state of a slot die and a state of ink applied to a substrate by an image capture unit during a coating process using the slot die, and then, controls operation of the slot die and transfer of the substrate in real time, thereby enabling real-time monitoring of the state of the slot die and the state of the ink applied to the substrate and thinly and uniformly applying the ink to the substrate, as well as a control method for the same.

Technical objects of the present invention are not particularly limited to the above description, and other technical objects not mentioned herein would be obviously understood from the following description by a person having ordinary knowledge and skill in the art to which the present invention pertains (‘the person skilled in the art’).

### Technical Solution

In order to accomplish the above objects, a slot die coating device according to one embodiment of the present invention includes: a slot die for conducting a coating process by applying ink to a substrate; an image capture unit positioned adjacent to the slot die, which captures images of a state of the slot die and a state of the ink applied to the substrate during the coating process; and a control unit for controlling operation of the slot die according to a result of comparison between an image captured by the image capture unit and a reference image, wherein the slot die includes: a first body having a cavity in which the ink supplied from the outside is contained; a second body disposed to be spaced from the first body; and a shim plate coupled between the first body and the second body, which has an outlet communicating with the cavity in order to discharge the ink contained in the cavity, and at least one protrusion exposed to the outside of the first body and the second body, and wherein the control unit sets the reference image on the basis of the at least one protrusion, and compares the image captured by the image capture unit and the reference image.

Further, the slot die is disposed at a position adjacent to the outlet and further includes at least one dispersion member to disperse the ink.

Further, the outlet may include multiple slits that are open downward.

Meanwhile, the image capture unit may include: at least one first camera which is disposed on at least one among a front end and a rear end of the slot die in a transfer direction of the substrate and photographs a coating edge of the ink discharged from the slot die; and at least one second camera which is disposed on at least one among both ends of the slot die and photographs a meniscus of the ink discharged from the slot die. Further, the control unit may compare the coating edge of the ink discharged from the slot die, which was photographed by the at least one first camera, with a first reference image, and may further compare the image of the ink photographed by the second camera with a second reference image, so as to control operation of the slot die.

Further, the image capture unit may further include a photographing driver for reciprocally driving the at least one first camera in a length direction of the slot die.

Meanwhile, the present invention may further include a slot die driver which is connected to the slot die and drives the slot die to shift the slot die to another position, and an ink supply unit which is connected to the slot die driver and supplies the ink to the slot die, wherein the control unit may control the slot die driver to regulate a position of the slot die according to a result of comparison between the image captured by the image capture unit and the reference image, and may further control the ink supply unit to adjust an amount of ink supplied to the slot die.

Further, in order to accomplish the above objects, the control method of a slot die coating device according to one embodiment of the present invention may include: starting a coating process of applying ink to a substrate by a slot die; capturing images of a state of the slot die and a state of the ink applied to the substrate by an image capture unit during the coating process; setting a reference image by a control unit on the basis of at least one protrusion formed on a shim plate provided in the slot die; and controlling operation of the slot die by the control unit according to a result of comparison between the image captured by the image capture unit and the reference image.

In this regard, a process of capturing images of the state of the slot die and the state of the ink applied to the substrate by the image capture unit may include: photographing a coating edge of the ink discharged from the slot die using at least one camera, which is disposed on at least one among the front end and the rear end of the slot die in a transfer direction of the substrate; and photographing a meniscus of the ink discharged from the slot die using at least one second camera, which is disposed on at least one among both ends of the slot die.

Further, a process of controlling the operation of the slot die by the control unit according to a result of comparison between the image captured by the image capture unit and the reference image may include: comparing the coating edge of the ink discharged from the slot die, which was photographed by the at least one first camera, with a first reference image by the control unit; comparing the meniscus of the ink, which was photographed by the at least one second camera, with a second reference image by the control unit; and controlling the operation of the slot die by the control unit according to a result of comparison between the coating edge of the ink discharged from the slot die and the first reference image and according to another result of comparison between the meniscus of the ink and the second reference image.

Meanwhile, a process of controlling the operation of the slot die by the control unit according to a result of comparison between the image captured by the image capture unit and the reference image may include: controlling the slot die driver, which changes the position of the slot die, to regulate the position of the slot die by the control unit; and controlling the ink supply unit, which supplies the ink to the slot die, to adjust an amount of ink supplied to the slot die by the control unit.

Concrete contents of other embodiments are included in the detailed description and the drawings.

### Advantageous Effects

With regard to the slot die coating device and the control method for the same according to one embodiment of the present invention, the operation of a slot die may be controlled in real time by capturing images of a state of the slot die and a state of ink applied to a substrate by the image capture unit during the coating process using the slot die, thus enabling real-time monitoring of the state of the slot die and the state of the ink applied to the substrate, and the substrate may be thinly and uniformly coated with the ink.

Further, with regard to the slot die coating device and the control method for the same according to one embodiment of the present invention, the image capture unit may consist of a first camera for photographing a shape of the ink discharged from the slot die and a second camera for photographing a figure between the slot die and the substrate in order to capture images of the state of the slot die and the state of the ink applied to the substrate during the coating process, thus enabling real-time monitoring.

Further, with regard to the slot die coating device and the control method for the same according to one embodiment of the present invention, at least one protrusion exposed to the outside of a first body and a second body may be formed on the shim plate, and the control unit may set a reference image on the basis of the at least one protrusion and compare an actually-captured image with the reference image, thereby more accurately real-time monitoring the state of the slot die and the state of the ink applied to the substrate during the coating process.

Further, with regard to the slot die coating device and the control method for the same according to one embodiment of the present invention, an ink dispersion member may be provided at an outlet of the slot die, so as to further improve uniformity in application of the ink to the substrate.

Effects of the present invention are not particularly limited to the above-described effects, and other effects not mentioned above will be more clearly understood by the person skilled in the art from the appended claims.

### DESCRIPTION OF DRAWINGS

FIG. 1 is a perspective view schematically illustrating a structure of the slot die coating device according to one embodiment of the present invention.

FIG. 2 is an exploded-perspective view schematically illustrating a first example of the slot die provided in the slot die coating device according to one embodiment of the present invention.

FIG. 3 is a view showing a condition of capturing images in a length direction of the slot die by the image capture unit provided in the slot die coating device according to one embodiment of the present invention.

FIG. 4 is a view showing a condition of capturing images in a width direction of the slot die by the image capture unit provided in the slot die coating device according to one embodiment of the present invention.

FIG. 5 is an exploded-perspective view schematically illustrating a second example of the slot die provided in the slot die coating device according to one embodiment of the present invention.

FIG. 6 is an exploded-perspective view schematically illustrating a third example of the slot die provided in the slot die coating device according to one embodiment of the present invention.

FIG. 7 is an exploded-perspective view schematically illustrating a fourth example of the slot die provided in the slot die coating device according to one embodiment of the present invention.

FIG. 8 is a perspective view schematically illustrating another example of the image capture unit provided in the slot die coating device according to one embodiment of the present invention.

FIG. 9 is a flowchart illustrating a control method of the slot die coating device illustrated in FIG. 1.

FIG. 10 is a perspective view schematically illustrating a structure of the slot die coating device according to another embodiment of the present invention.

FIG. 11 is a flowchart illustrating a control method of the slot die coating device illustrated in FIG. 10.

### BEST MODE

Hereinafter, preferred embodiments of the present invention will be more concretely described with reference to the accompanying drawings so as to allow the present invention to be implemented by the person skilled in the art.

In the embodiments of the present invention, detailed description of technical matters well known in the art but not directly associated with the present invention will be omitted. This is for the purpose of omitting undesirable explanation to thus more clearly stipulate the concept of the present invention without clouding the same.

For the same reason, in the accompanying drawings, some components will be exaggeratedly demonstrated, omitted or schematically illustrated. Further, a size of each of the components does not fully reflect the real dimensions thereof. The same or corresponding components in the drawings are denoted by the same symbol or reference number.

Hereinafter, the present invention will be concretely described by means of the following examples with reference to the accompanying drawings, by which the slot die coating device and the control method for the same according to the present invention are specified.

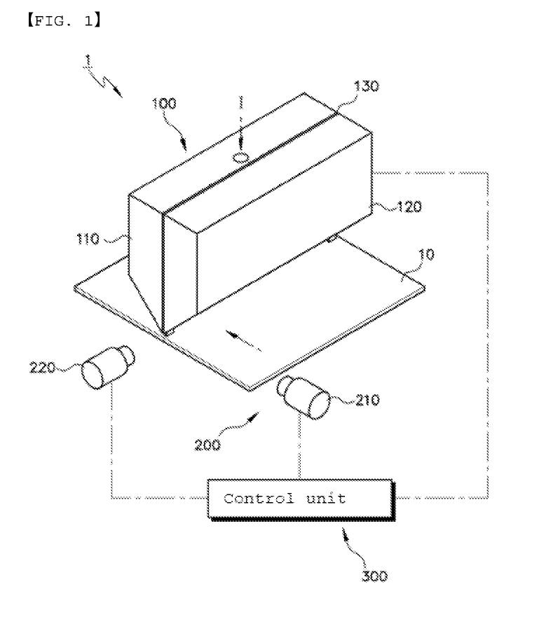

FIG. 1 is a perspective view schematically illustrating a structure of the slot die coating device according to one embodiment of the present invention.

As illustrated in FIG. 1, the slot die coating device 1 according to one embodiment of the present invention may include a slot die 100, an image capture unit 200 and a control unit 300.

The slot die 100 may conduct a coating process by applying ink to a substrate 10. The coating process using the slot die 100 may coat the substrate 10 having a wide width at once and, when supplying ink I from an ink storage tank (not shown) to the slot die 100, the ink is not exposed to air, thus preventing change in viscosity of the ink and inflow of impurities. Further, the above coating process has advantages such as excellent stability and reproduction of ink coating.

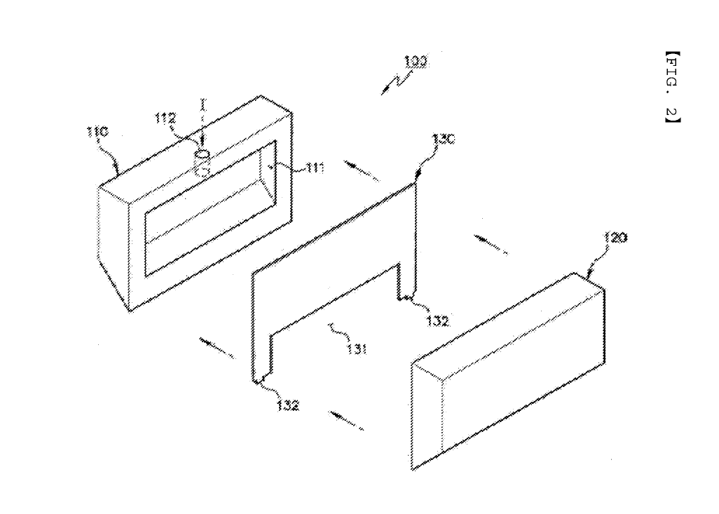

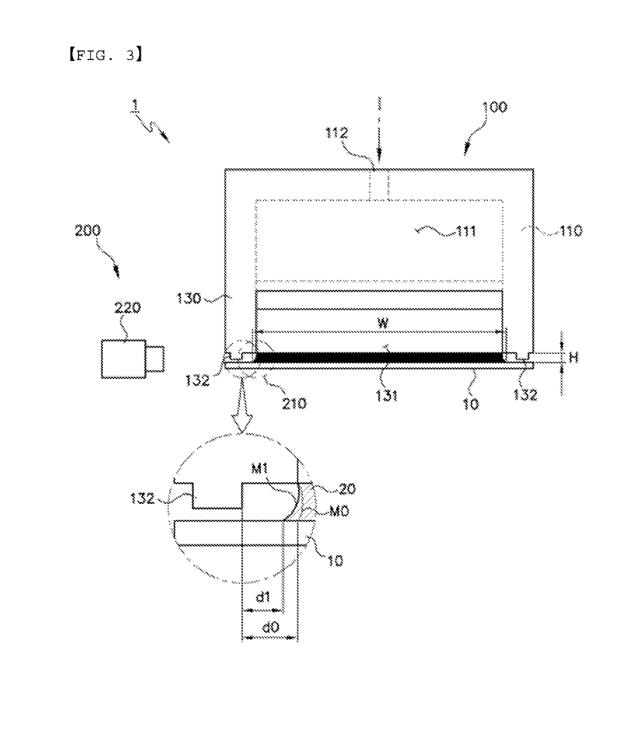

As illustrated in FIG. 1, the slot die 100 includes a first body 110, a second body 120 and a shim plate 130 coupled together, wherein the first body 110 may have a cavity 111 (FIG. 2) formed to receive the ink I therein, and the shim plate 130 may have an outlet 131 (FIG. 2) formed at the lower portion of the shim plate to discharge the ink 20 (FIG. 3). A specific structure of the slot die 100 will be more concretely described with reference to FIGS. 1 to 7.

The image capture unit 200 is disposed adjacent to the slot die 100, and may capture images of a state of the slot die 100 and a state of the ink 20 (FIG. 2) applied to the substrate during the coating process. The image capture unit 200 may use a complementary metal-oxide semiconductor (CMOS) camera, a charge-coupled device (CCD) camera, or the like.

As illustrated in FIG. 1, the image capture unit 200 may have multiple cameras 210, 220, etc. at different positions adjacent to the slot die 100, wherein each of these cameras 210, 220, etc. may photograph a site between the slot die 100 and the substrate 10 at a predetermined position, so as to capture images of a state of the slot die 100 and a state of the ink, which was discharged from the slot die 100 and then applied to the substrate 10. Herein, the state of the slot die 100 means whether ink is discharged from the slot die 100 or not, an amount of ink discharged from the slot die 100, a position (e.g., height) of the slot die 10 relative to the substrate 10, or the like, while the state of the ink 20 (FIG. 2) means a meniscus, a coating edge or a coating width of the ink 20 (FIG. 2) coated on the substrate 10.

Preferably, the image capture unit 200 may include: at least one camera 210, which is disposed on at least one among a front end and a rear end of the slot die 100 in a transfer direction of the substrate 10; and at least one second camera 220, which is disposed on at least one among both ends of the slot die 100.

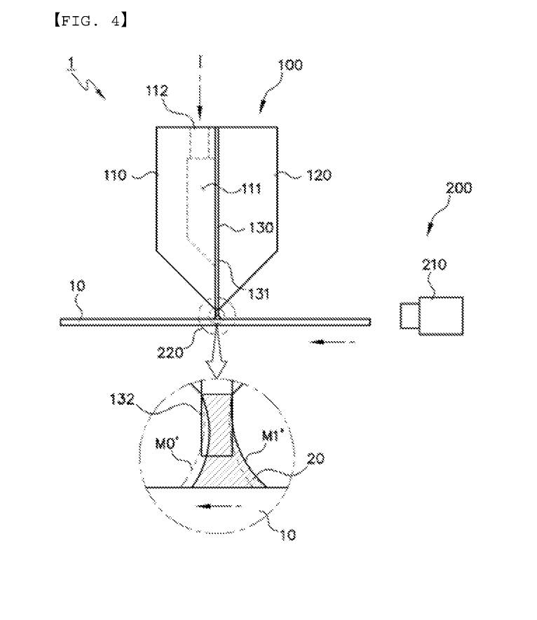

More particularly, the first camera 210 is disposed throughout both sides of the slot die 100 or on a part thereof in a width direction of the slot die 100, and may photograph the coating edge M1 (FIG. 3) of the ink discharged from the slot die 100, while the second camera 220 is disposed throughout both ends of the slot die 100 or on a part thereof in a length direction of the slot die 100 formed lengthy, and may photograph the meniscus M1′ (FIG. 4) of the ink discharged from the slot die 100. If necessary, a plurality of first cameras 210 and second cameras 220 may be provided.

Although FIG. 1 illustrates an example wherein a first camera 210 is provided on the front end of the slot die 100 and a second camera 220 is provided on one end of the slot die 100, the number of the first camera 210 and the second camera and/or a location at which these cameras are positioned could be altered without limitation by the person skilled in the art if desired.

The control unit 300 is connected to the slot die 100 and the image capture unit 200, and may control operation of the slot die 100 according to a result of comparison between an image captured by the image capture unit 200 and a reference image. That is, the control unit 300 accepts actual images captured and transmitted by the image capture unit 200 during the coating process, followed by comparing the same with a preset reference image and determining a state of the slot die 100 and a state of the ink applied to the substrate 10. Thereafter, operation of the slot die 100 may be controlled to match the actual image with the reference image. Herein, the operation of the slot die 100 means a position of the slot die 100 (e.g., height) relative to the substrate 10, a discharge amount of ink, etc.

As illustrated in FIG. 1, if the slot die coating device 1 includes a first camera 210 disposed on the front end of the slot die 100 in a transfer direction of the substrate and a second camera 220 disposed on one end of the slot die 100, the control unit 300 may compare a coating edge of the ink discharged from the slot die 100, which was photographed by the first camera 210, with a first reference image, and may also compare a meniscus of the ink, which was photographed by the second camera 220, with a second reference image, thereby controlling the operation of the slot die 100.

As described below, the control unit 300 may compare the actual image captured by the image capture unit 200 with the reference image, and therefore, may regulate a position of the slot die 100 or regulate a flow rate of the ink supplied to the slot die 100, so as to match a state of the ink discharged from the slot die 100 and applied to the substrate 10 with the reference image.

As such, the slot die coating device 1 according to one embodiment of the present invention may capture images of a state of the slot die 100 and a state of the ink applied to the substrate and may control the operation of the slot die 100 in real time, thereby real-time monitoring the state of the slot die 100 and the state of the ink applied to the substrate 10 and also thinly and uniformly applying the ink to the substrate 10.

Although not illustrated herein, a substrate 10 transfer unit (not shown) for transferring the substrate 10 may be provided at a location adjacent to the slot die coating device 1 (the lower portion of the slot die coating device 1 in the example shown in FIG. 1). For instance, for a roll-to-roll printing device that conducts a coating process of a film type substrate 10 using the slot die 100, the substrate 10 transfer unit may further include: an unwinder for continuously unwinding the film and feeding the same to the slot die coating device 1; are winder for continuously winding the film supplied after completion of the coating process in the slot die coating device 1; and multiple transfer rollers to guide the transfer of the film. In this regard, in order to control a state of the ink discharged from the slot die 100 and then applied to the substrate 100, if necessary, the control unit 300 may be connected to the substrate 10 transfer unit to regulate a transfer speed of the substrate 10.

Hereinafter, referring to FIG. 2, the following description will be provided to more concretely explain a structure of the slot die 10 provided in the slot die coating device 1 according to one embodiment of the present invention.

FIG. 2 is an exploded-perspective view schematically illustrating an example of the slot die provided in the slot die coating device according to one embodiment of the present invention.

As illustrated in FIG. 2, the slot die 100 may include a first body 110, a second body 120 and a shim plate 130.

The first body 110 has a cavity 111, in which the ink I supplied from the outside is contained, and the second body 120 may be disposed to be spaced apart from the first body 110. As illustrated in FIG. 2, each of the first body 110 and the second body 120 may be formed to extend lengthwise and have a length corresponding to a width of the substrate 10, and may also have a cross-section that narrows downward. Further, the first body 110 may have a cavity 111 in which the ink supplied from the outside is contained. Further, an input hole 112 may be formed at top end of the first body 110, through which a pipeline to receive the ink from an external ink storage tank (not shown) is connected.

The shim plate 130 may be made of a metal material which has a thin flat board shape formed to be substantially identical to a face on which the first body 110 and the second body 120 are coupled together, and may be interposed and coupled between the first body 110 and the second body 120. The shim plate 130 has an outlet communicating with the cavity 111 formed in the first body 110, in order to discharge the ink contained in the cavity 111. As illustrated in FIG. 2, the outlet 131 may be formed at the central bottom end of the shim plate 130 to extend in a length direction of the first body 110 and the second body 120. The outlet 131 may determine a coating width of the ink discharged to the substrate 10.

As illustrated in FIG. 2, the shim plate 130 of the slot die 110 provided in the slot die coating device 1 according to one embodiment of the present invention may have at least one protrusion 132 exposed to the outside of the first body 110 and the second body 120. FIG. 2 illustrates an example where in a pair of protrusions 132 is formed at both ends of the shim plate 130 around the outlet 131 formed at the central bottom end of the shim plate 130, in order to be protruded downward, however, the present invention is not particularly limited to the above configuration, which could be modified without limitation by the person skilled in the art, if desired.

Meanwhile, the control unit 300 in the slot die coating device 1 according to one embodiment of the present invention may set a reference image on the basis of the at least one protrusion 132 formed on the shim plate 130 of the slot die 100, and may compare an image captured by the image capture unit 200 with the reference image.

In general, a common difference (or tolerance) in processing shapes of the first body 110, the second body 120 and the shim plate 130 of the slot die 100 ranges from several μm to several tens of μm. However, since an arrangement error due to coupling of the first body 110 and the second body 120 by the shim plate 130 reaches about several hundred μm or more, if a state of the image captured by the image capture unit 200 is determined on the basis of the first body 110 or the second body 120, accurate monitoring is impossible due to the arrangement error of the actually arranged shim plate 130. Accordingly, since the present invention may determine the state of the image captured by the image capture unit 200 on the basis of the protrusion 132 formed on the shim plate 130 to be exposed to the outside of the first body 110 and the second body 120, it is possible to monitor the state of the image captured with accuracy in the range of several μm to several tens of μm regardless of the arrangement error of the shim plate 130.

As illustrated in FIG. 1, if the image capture unit 200 consists of at least one first camera 210, which is disposed on at least one among a front end and a rear end of the slot die 100 in a transfer direction of the substrate 10, and at least one second camera 220 disposed on at least one among both ends of the slot die 100, the control unit 300 may compare a coating edge of the ink discharged from the slot die 100, which was photographed by the at least one first camera 210, with a first reference image, and may also compare a meniscus of the ink photographed by the at least one second camera 220 with a second reference image.

FIG. 3 is a view showing a condition of capturing images in a length direction of the slot die by the image capture unit in the slot die coating device according to one embodiment of the present invention, while FIG. 4 is a view showing a condition of capturing images in a width direction of the slot die by the image capture unit in the slot die coating device according to one embodiment of the present invention.

First, the first camera 210 may be disposed to lead the photographing direction to face the outlet 131 in the width direction of the slot die 100, and FIG. 3 illustrates an example wherein one first camera 210 is disposed at a face of the outlet 131 formed lengthwise in the length direction of the slot die 100.

As shown in FIG. 3, the first camera 210 may photograph a coating edge M1 of the ink 20 discharged from the slot die 100 in real time during the coating process of the substrate 10. In this case, the first camera 210 may photograph such that the protrusion 132 formed on the shim plate 130 and the coating edge M1 of the ink 20 discharged from the end of the outlet 131 are all in view.

The coating edge M1 of the ink photographed by the first camera 210 may be used to calculate a gap H between the slot die 100 and the substrate 10 and a coating width W of the ink coated on the substrate 10. Of course, the gap H between the slot die 100 and the substrate 10 and the coating width W of the ink coated on the substrate 10 may be directly photographed by the first camera 210.

When the first camera 210 photographs the coating edge M1 of the ink 20 discharged from the slot die 100, the control unit 300 may use the photographed image and set a first reference image M0, which was predetermined in a steady state condition on the basis of the protrusion 132 formed at bottom end of the shim plate 130. That is, the control unit 300 may set the first reference image M0, which was predetermined in regard to a condition such as a coating thickness to be coated on the substrate 10, a transfer speed of the substrate 10, etc., at a reference distance d0 between the protrusion 132 and the end of the outlet 131.

Further, the control unit 300 may compare the first reference image M0 with the actually photographed coating edge M1 of the ink 20, so as to determine a state of the slot die 100 such as a position of the slot die 100, an amount of the ink 20 discharged from the slot die 100, etc., and a state of the ink 20 discharged from the slot die 100 and then applied to the substrate 10 during the coating process. For instance, the control unit 300 may calculate the amount of the ink 20 discharged from the slot die 100 and/or the coating width W of the ink coated on the substrate 10 by using an actual distance d1 to the actually photographed coating edge M1 of the ink 20, on the basis of the protrusion 132. In this regard, if the reference distance d0 is larger than the actual distance d1, it may be determined that the discharge amount of the ink 20 coated on the substrate 10 exceeds the predetermined reference.

Lastly, the control unit 300 may control operation of the slot die 100 such that the actually photographed coating edge M1 of the ink 20 matches the first reference image M0 depending upon the state of the slot die 100. For instance, if the reference distance d0 is larger than the actual distance d1 to the actually photographed coating edge M1 of the ink 20, on the basis of the protrusion 132, the control unit 300 may increase an amount of ink I supplied to the slot die 100.

Meanwhile, the second camera 220 may be disposed to lead a photographing direction to face the outlet 131 in a length direction of the slot die 100. FIG. 4 illustrates an example wherein one second camera 220 is disposed at one end of the slot die 100. The second camera 220 may photograph a meniscus M1′ of the ink 20 discharged from the slot die 100 and applied to the substrate 10 in real time during the coating process.

As illustrated in FIG. 4, the second camera 220 may photograph the meniscus M1′ of the ink 20 discharged from the slot die 100 in real time during the coating process. Further, when the second camera 220 photographs the meniscus M1′ of the ink 20 discharged from the slot die 100, the control unit 300 may use the photographed image and set a second reference image M0′, which was predetermined in regard to a condition such as a coating thickness to be coated on the substrate 10, a transfer speed of the substrate 10, etc. on the basis of the protrusion 132 formed at the bottom end of the shim plate 130.

Further, the control unit 300 may compare the second reference image M0′ with the actually photographed coating edge M1′ of the ink 20, so as to determine a state of the slot die 100 such as a position of the slot die 100, an amount of the ink 20 discharged from the slot die 100, etc., and a state of the ink 20 discharged from the slot die 100 and then applied to the substrate 10 during the coating process, followed by controlling operation of the slot die 100 so as to match the actually photographed meniscus M1′ of the ink 20 with the second reference image M0′.

As such, the slot die coating device 1 according to one embodiment of the present invention may have an image capture unit 200, including: a first camera 210 to photograph a coating edge M1 of ink 20 discharged from a slot die 100; and a second camera 220 to photograph a meniscus M1′ of the ink 20 discharged from the slot die 100, so as to capture images of a state of the slot die 100 and a state of ink applied to the substrate 10 during a coating process, thereby monitoring the same in real time. Further, a shim plate 130 includes at least one protrusion 130 exposed to the outside of a first body 110 and a second body 120, and a control unit sets a reference image on the basis of at least one protrusion 132 and compares the reference image with the actually-captured image, thereby more accurately real-time monitoring the state of the slot die 100 and the state of the ink 20 applied to the substrate 10 during the coating process.

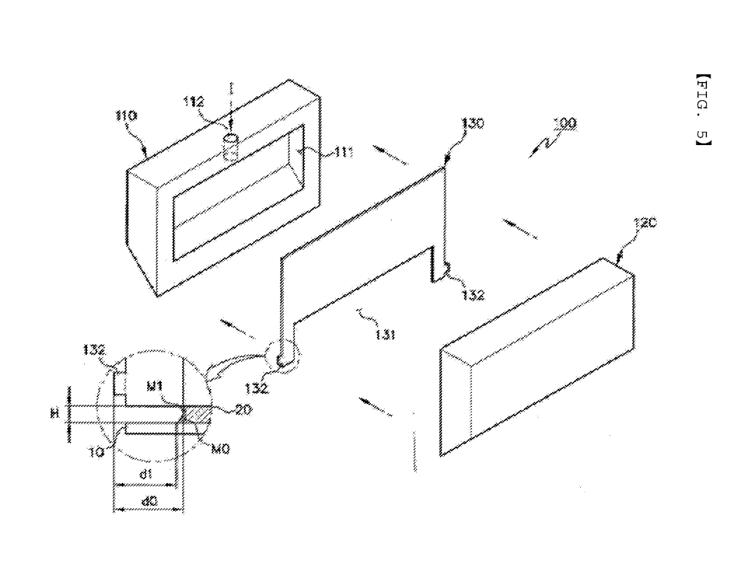

Hereinafter, with reference to FIGS. 5 to 7, a modification of the slot die 100 provided in the slot die coating device 1 according to one embodiment of the present invention will be more concretely described.

FIG. 5 is an exploded-perspective view schematically illustrating a second example of the slot die provided in the slot die coating device according to one embodiment of the present invention.

Unlike the shim plate 130 of the slot die 100 shown in FIG. 2, the shim plate 130 of the slot die 100 shown in FIG. 5 may have at least one protrusion 132, which is exposed to the outside through both of the first body 110 and the second body 120. For instance, if a gap H between the slot die 100 and the substrate 10 is too narrow, it is preferable to form the protrusion 132 on either side or both sides of the shim plate 130 rather than the bottom end of the shim plate 130. However, as illustrated in FIG. 5, if the protrusion 132 is formed on either side or both sides of the shim plate 130, a field of view (FOV) of the first camera 210 must be larger, compared to adopting the shim plate 130 of the slot die 100 illustrated in FIG. 5.

FIG. 5 illustrates an example wherein two protrusions 132 are formed at both sides of the shim plate 130, however, this configuration could be modified without limitation by the person skilled in the art if desired.

Meanwhile, the slot die 100 provided in the slot die coating device 1 according to one embodiment of the present invention may further include at least one dispersion member, which is disposed at a position adjacent to the outlet 131, for dispersing the ink 20 discharged through the outlet 131.

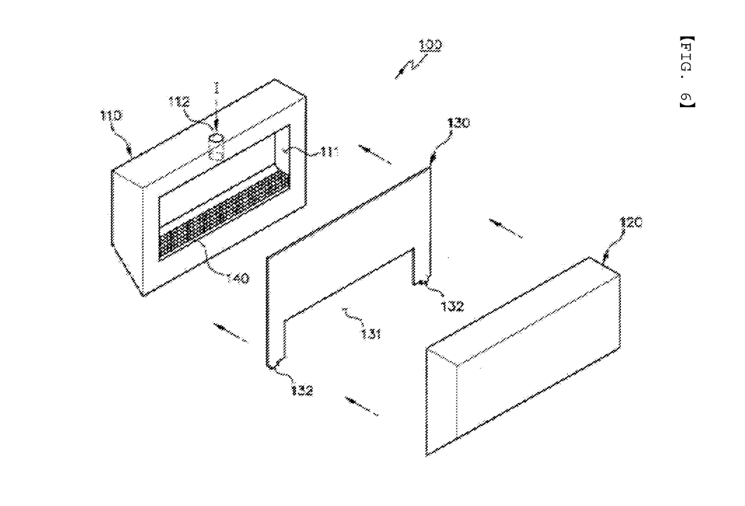

FIG. 6 is an exploded-perspective view schematically illustrating a third example of the slot die provided in the slot die coating device according to one embodiment of the present invention.

As illustrated in FIG. 6, the dispersion member may use multiple spherical bodies regularly arranged in the outlet 131 of the slot die 100. This is because the ink 20 may be easily dispersed and flow into gaps between the multiple regularly-arranged spherical bodies, as described above. Further, each of these spherical bodies for forming the dispersion member may be made of a ceramic material because the ceramic spherical body has excellent anti-corrosive properties to thus prevent corrosion caused by the ink 20. FIG. 6 illustrates an example wherein the dispersion member consists of multiple spherical bodies, each of which is made of a ceramic material. However, the above configuration is not particularly limited but may be freely altered by the person skilled in the art if desired.

As such, the slot die 100 provided in the slot die coating device 1 according to one embodiment of the present invention may have a dispersion member to help disperse the ink 20 therein, so as to uniformly apply the ink 20, which was discharged from the outlet 131 of the slot die 100, to the substrate 10.

Meanwhile, the outlet 131 of the slot die 100 provided in the slot die coating device 1 according to one embodiment of the present invention may include multiple slits 133 formed to be open downward.

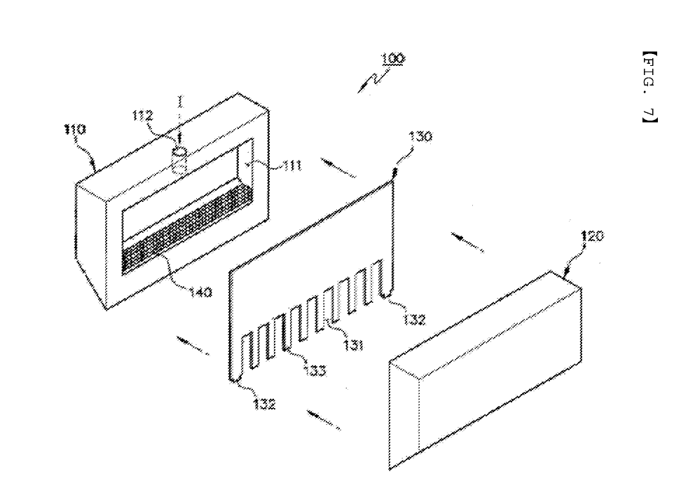

FIG. 7 is an exploded-perspective view schematically illustrating a fourth example of the slot die provided in the slot die coating device according to one embodiment of the present invention.

As illustrated in FIG. 7, the shim plate 130 has a thin flat board shape formed to be substantially identical to a face on which the first body 110 and the second body 120 are coupled together, and has an outlet 131 which communicates with a cavity 111 formed on the first body 110 and discharges the ink 20 contained in the cavity, wherein multiple slits 133 opening downward may be formed at regular intervals and at a position adjacent to the outlet 131.

As such, the shim plate 130 of the slot die 100 provided in the slot die coating device 1 according to one embodiment of the present invention may have multiple slits 133 that are open downward, which are formed at a position adjacent to the outlet 131, so as to uniformly apply the ink 20, which was discharged from the outlet 131 of the slot die 100, to the substrate 10.

Meanwhile, the image capture unit 200 provided in the slot die coating device 1 according to one embodiment of the present invention may further include a photographing driver 230 to reciprocally drive at least one first camera 210 in a length direction of the slot die 100.

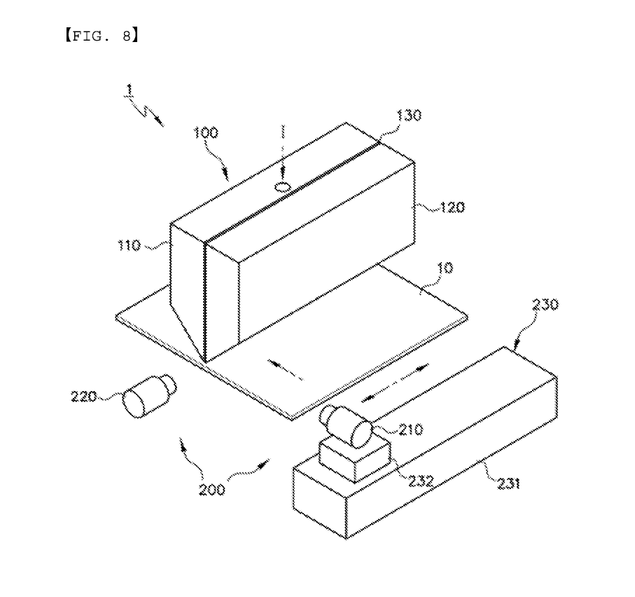

FIG. 8 is a perspective view schematically illustrating another example of the image capture unit provided in the slot die coating device according to one embodiment of the present invention.

Unlike the image capture unit 200 illustrated in FIG. 1, the image capture unit 200 illustrated in FIG. 8 may further include a photographing driver 230 to reciprocally drive one first camera 210 in a length direction of the slot die 100. This photographing driver 230 may be used to shift the first camera 210 if the first camera 210 has a small field of view (FOV) and could not photograph both the protrusion 132 formed on the shim plate 130 and the coating edge M1 of the ink 20 discharged from the end of the outlet 131 at once. Otherwise, the photographing driver 230 may be used to reciprocally move one first camera 210 to both ends of the outlet 131 formed in the shim plate 130 during the coating process, so as to photograph a coating edge M1 of the ink discharged from both ends of the slot die 100 or a coating width W of the ink coated on the substrate 10.

Although not illustrated in detail, the photographing driver 230 may consist of a drive actuator 231 for generating linear and rotational driving forces, and a fixed block 232 for fixing the first camera 210, which is connected to the drive actuator 231 and driven by the drive actuator 231 in order to run between both sides of the slot die 100. Preferably, the drive actuator 231 may be embodied as a linear motion system that transforms rotational driving force generated by a drive motor (not shown) into linear driving force through a ball screw (not shown).

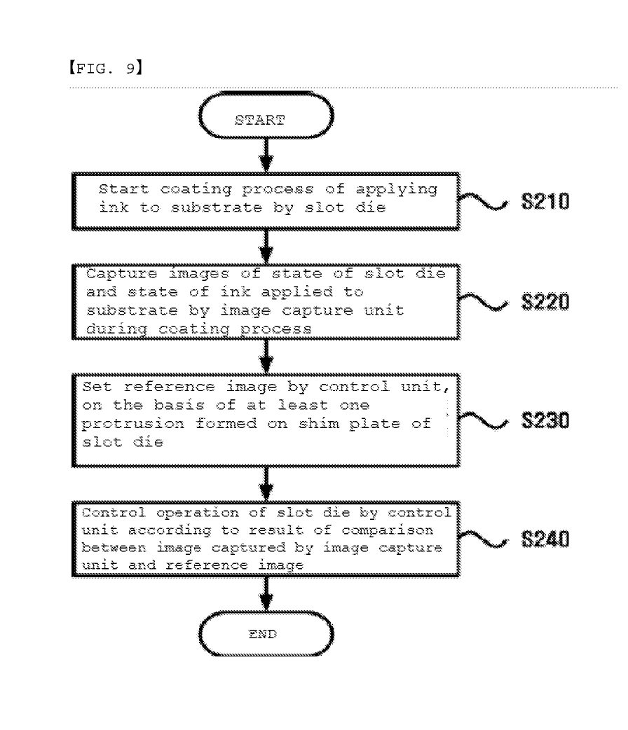

Hereinafter, referring to FIG. 9, the following description will be provided to more concretely explain a control method of the slot die coating device 1 according to one embodiment of the present invention.

FIG. 9 is a flowchart illustrating a control method of the slot die coating device shown in FIG. 1.

As illustrated in FIG. 9, when the slot die 100 starts a coating process of applying the ink 20 to the substrate 10 (S210), the image capture unit 200 may capture images of a state of the slot die 100 and a state of the ink 20 applied to the substrate 10 in real time during the coating process (S220). While real-time photographing the state of the slot die 100 and the state of the ink 20 applied to the substrate by the image capture unit 200 (S220), the control unit 300 may set a reference image, which was predetermined in a steady state condition, on the basis of at least one protrusion 132 formed on the shim plate 130 of the slot die 100 (S230).

Lastly, the control unit 300 may determine the state of the slot die 100 (e.g., a position of the slot die 100, an amount of the ink 20 discharged from the slot die 100, etc.) according to a result of comparison between an image captured by the image capture unit 200 and the reference image, followed by, according to the result of the determination, controlling operation of the slot die 100, in order to match a shape of the actually photographed ink 20 with the reference image in the steady state condition (S240).

Meanwhile, referring to FIG. 9, steps S220 to S240 may be performed at substantially the same time. Further, after step S240, steps S220 to S240 may be repeated until the coating process is completed.

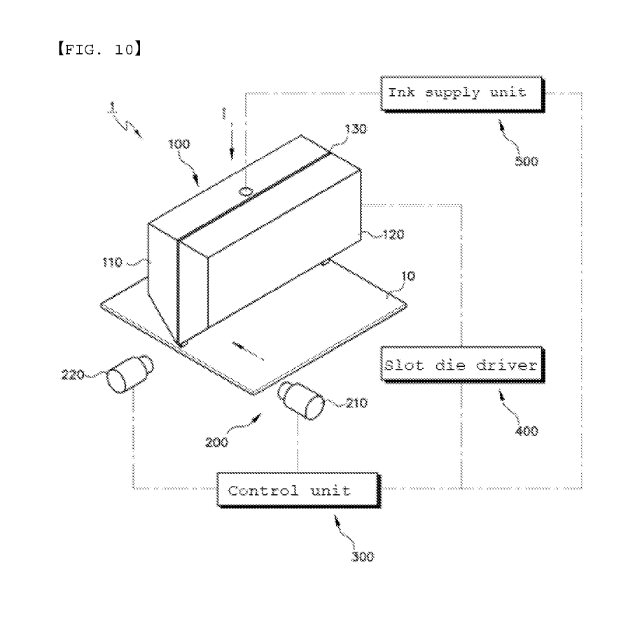

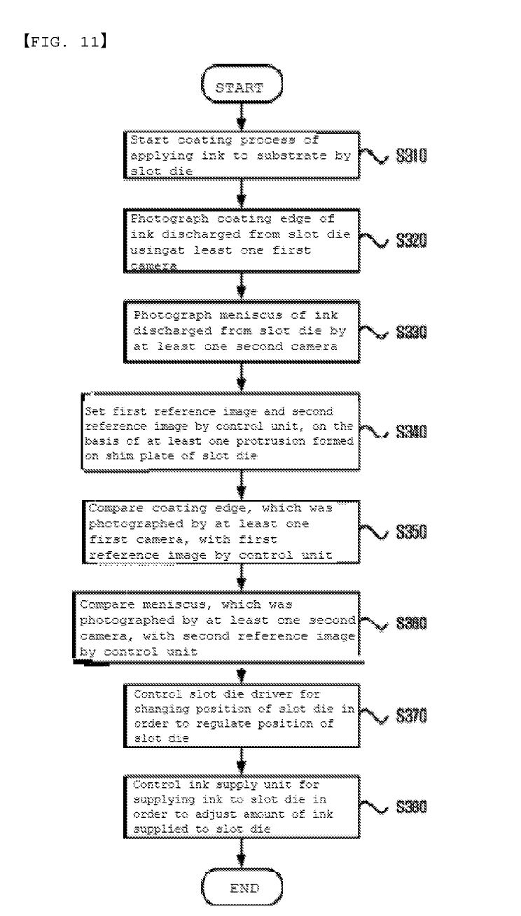

Hereinafter, referring to FIGS. 10 and 11, the following description will be provided to more concretely explain the slot die coating device 1 and a control method for the same according to another embodiment of the present invention. For convenience of description, detailed description of substantially the same configurations and processes as illustrated in FIGS. 1 to 9 are omitted, and instead, only differences will be mainly included in the following description.

FIG. 10 is a perspective view schematically illustrating a structure of the slot die coating device according to another embodiment of the present invention.

The slot die coating device 1 shown in FIG. 10 according to another embodiment of the present invention may further include a slot die driver 400 and an ink supply unit 500 in addition to the structure of the slot die coating device 1 shown in FIG. 1 according to the embodiment of the present invention.

As described above, the control unit 300 may compare images captured by the image capture unit 200 during the coating process, that is, the coating edge M1 of the ink 20 discharged from the slot die 100, which was photographed by the first camera 210, and the meniscus M1′ of the ink 20 discharged from the slot die 100, which was photographed by the second camera 220, with the reference image, followed by determining a state of the slot die 100 and a state of the ink 20 applied to the substrate 10, and then, may regulate a position of the slot die 100 so as to control operation of the slot die 100.

As illustrated in FIG. 10, the slot die driver 400 is connected to the slot die 100, and may drive the slot die 100 so as to change a position of the slot die 100 according to a result of comparison between the images M1, M1′ captured by the image capture unit 200 and the reference images M0, M0′. For instance, as a result of real-time photographing the coating edge M1 of the ink 20 discharged from the slot die 100 during the coating process, if it is necessary to adjust a gap H between the slot die 100 and the substrate 10 in order to regulate a coating width W of the ink coated on the substrate 10, the slot die driver 400 may move the slot die 100 in up and down directions to thus adjust the gap H between the slot die 100 and the substrate 10.

Although not illustrated, the slot die driver 400 may linearly move the slot die 100 in three axial directions including the X-axis (e.g., a transfer direction of the substrate 10), the Y-axis (e.g., a width direction of the substrate) and the Z-axis (e.g., vertical direction or up and down directions), in addition, may rotate or tilt the slot die around a specific axis in a vertical or horizontal plane. The slot die driver 400 may use a linear motion system so as to move the slot die driver 400 in three axial directions, and may further use different types of actuators such as a drive motor, a rotational cylinder, etc., as well as a combined linear motion system, thus rotating or tilting the slot die 100.

The ink supply unit 500 is connected to the slot die 100, and may supply ink I from an ink storage tank (not shown) to the cavity 111 in the slot die 100 and adjust a supply amount of the ink I. For instance, as a result of real-time photographing the coating edge M1 of the ink 20 discharged from the slot die 100 during the coating process, if it is necessary to adjust a supply amount of the ink 20 in order to regulate a coating width W of the ink coated on the substrate 10, the ink supply unit 500 may adjust the amount of ink I supplied to the slot die 100.

Although not illustrated, the ink supply unit 500 may consist of an ink supply pipeline to connect the ink storage tank and the slot die 100 and a flow rate control valve mounted on the ink supply pipeline to control a supply amount of the ink 20.

As such, according to a result of comparison between the images M1, M1′ captured by the image capture unit 200 and the reference images M0, M0′, the control unit 300 in the slot die coating device 1 shown in FIG. 10 according to another embodiment of the present invention may control the slot die driver 400 to regulate a position of the slot die 100 so as to match the actually photographed shapes M1, M1′ of the ink 20 with the shapes M0, M0′ in a steady state condition, and may further control the ink supply unit 500 so as to adjust an amount of the ink I supplied to the slot die 100.

Meanwhile, assuming that a transfer speed of the substrate 10 is constant, a coating thickness of the ink coated on the substrate 10 may be determined by a coating width W of the ink coated on the substrate 10. Further, this coating width W of the ink coated on the substrate 10 may be determined by the gap H between the slot die 100 and the substrate 10 and the amount of the ink I supplied to the slot die 100. Therefore, in order to maintain a constant coating width W of the ink coated on the substrate 10, the control unit 300 may properly control the slot die driver 400 and the ink supply unit 500.

Hereinafter, referring to FIG. 11, the following description will be provided to concretely explain a control method of the slot die coating device 1 with the above configurations according to another embodiment of the present invention.

FIG. 11 is a flowchart illustrating a control method of the slot die coating device shown in FIG. 10.

As illustrated in FIG. 11, when the slot die 100 starts a coating process of applying the ink 20 to the substrate 10 (S310), at least one first camera 210 disposed on at least one among the front end and the rear end of the slot die 100 in a transfer direction of the substrate 10 may photograph a coating edge M1 of the ink 20 discharged from the slot die 100 in real time (S320), while real-time photographing a meniscus M1′ of the ink discharged from the slot die 100 by at least one second camera 220 disposed on at least one among both ends of the slot die 100 (S330).

As illustrated in FIG. 1, when the slot die coating device 1 has the first camera 210 disposed at the front end of the slot die in a transfer direction of the substrate 10 and the second camera 220 disposed at one end of the slot die 100, the first camera 210 may photograph the coating edge M1 of the ink 20 discharged from the slot die 100 in real time while the second camera 220 may photograph the meniscus M1′ of the ink 20 discharged from the slot die 100 in real time.

While real-time photographing a state of the slot die 100 and a state of the ink 20 applied to the substrate 10 using the first camera 210 and the second camera 220 (S320, S330), respectively, the control unit 300 may set a first reference image M0 and a second reference image M0′, respectively, on the basis of at least one protrusion 132 formed on the shim plate 130 of the slot die 100 (S340). A method of setting the first reference image and the second reference image on the basis of the protrusion 132 formed on the shim plate 130 is substantially the same as the procedures described with reference to FIGS. 3 and 4.

Thereafter, the control unit 300 may compare the coating edge M1 of the ink 20 discharged from the slot die 100, which was photographed in real time by the at least one first camera 210, with the first reference image M0 (S350), and may also compare the meniscus M1 of the ink 20, which was photographed in real time by the at least one second camera 220, with the second reference image M0′ (S360).

Lastly, according to a result of comparison between the coating edge M1 of the ink 20 actually photographed by the first camera 210 and the first reference image M0 and a result of comparison between the meniscus M1′ actually photographed by the second camera 220 and the second reference image M0′, the control unit 300 may determine a position of the slot die 100, an amount of the ink 20 discharged from the slot die 100, etc. during the coating process, followed by controlling the slot die driver 400 for moving a position of the slot die 100 to thus regulate the position of the slot die 100 (S370). Further, the control unit may control the ink supply unit 500 for supplying the ink 20 to the slot die 100, thus adjusting an amount of ink 20 supplied to the slot die 100 (S380).

Meanwhile, FIG. 11 illustrates that steps S320 to S380 may be performed at substantially the same time, and these steps S320 to S380 can be repeated after S380 until the coating process is completed.

As described above, with regard to the slot die coating device 1 and the control method for the same according to one embodiment of the present invention, operation of the slot die 100 may be controlled in real time by capturing images of a state of the slot die 100 and a state of the ink 20 applied to the substrate 10 by means of the image capture unit 200 during the coating process using the slot die 100, thereby real-time monitoring the state of the slot die 100 and the state of the ink 20 applied to the substrate 10 and thinly and uniformly applying the ink 20 to the substrate 10. Further, since the image capture unit 200 includes a first camera 210 for photographing a coating edge M1 of the ink 20 discharged from the slot die 100 and a second camera 220 for photographing a meniscus M1′ of the ink 20 discharged from the slot die 100, the state of the slot die 100 and the state of the ink 20 applied to the substrate 10 may be photographed during the coating process, thereby real-time monitoring the same.

Further, with regard to the slot die coating device 1 and the control method for the same according to one embodiment of the present invention, the shim plate 130 has at least one protrusion 132 exposed to the outside of the first body 110 and the second body 120, and the control unit 300 may set a reference image on the basis of the at least one protrusion 132 and compare the reference image with actually photographed image, thereby more accurately real-time monitoring the state of the slot die 100 and the state of the ink 20 applied to the substrate 10 during the coating process. Further, a dispersion member for dispersing the ink 20 may be provided on the outlet 131 of the slot die 100 provided in the slot die coating device 1, so as to further improve uniformity in application of the ink 20 to the substrate 10.

Herein, the present invention has been described with reference to an example of a coating device that conducts a coating process on a substrate 10 using a slot die 100, however, an application range of the present invention is not particularly limited to the above. Instead, the present invention is applicable to diverse processes and technical fields without limitation, including anything that involves a device for conducting a specific process on a substrate 10 by using a slot die 100 to discharge ink 20. Further, the present invention has been described with reference to an example of a coating device that conducts a coating process on a film type substrate 10 using a slot die 100 provided in a slot die coating device 1, however, an application range of the present invention is not particularly limited to the above. Instead, the present invention is applicable to diverse processes and technical fields without limitation, including anything that involves a device for conducting a specific process on a substrate 10 by using a slot die 100 to discharge ink 20.

Preferred embodiments of the present invention have been described in the present specification and drawings, and specific terms therein have been used only for the general purpose of more easily explaining the technical configurations of the present invention and to aid in understanding of the same, without particularly limiting the technical scope of the present invention. It would be obviously understood that, other than the embodiments disclosed herein, a variety of modifications and variations are possible on the basis of the technical spirit of the present invention by the person skilled in the art to which the present invention pertains.

### INDUSTRIAL APPLICABILITY

The present invention relates to a slot die coating device and a control method for the same and, more particularly, is applicable to a technical field in relation to a slot die coating device and a control method for the same, which enable real-time monitoring of a state of the slot die and a state of ink applied to a substrate, and thin and uniform application of the ink to the substrate.

1. As lot die coating device, comprising:
a slot die for conducting a coating process by applying ink to a substrate;
an image capture unit positioned adjacent to the slot die, and capturing images of a state of the slot die and a state of the ink applied to the substrate during the coating process; and
a control unit for controlling operation of the slot die according to a result of comparison between an image captured by the image capture unit and a reference image,
wherein the slot die includes:
a first body having a cavity in which the ink supplied from the outside is contained;
a second body disposed to be spaced apart from the first body; and
a shim plate coupled between the first body and the second body, and formed with an outlet communicating with the cavity in order to discharge the ink contained in the cavity and at least one protrusion exposed to the outside of the first body and the second body, and
wherein the control unit sets the reference image on the basis of the at least one protrusion, and compares the image captured by the image capture unit and the reference image.

2. The slot die coating device according to claim 1, wherein the slot die is disposed at a position adjacent to the outlet, and includes at least one dispersion member to disperse the ink discharged from the outlet.

3. The slot die coating device according to claim 2, wherein the outlet includes a plurality of slits being open downward.

4. The slot die coating device according to claim 1, wherein the image capture unit includes:
at least one first camera disposed on at least one among a front end and a rear end of the slot die in a transfer direction of the substrate, and photographing a coating edge of the ink discharged from the slot die; and
at least one second camera disposed on at least one end among both ends of the slot die, and photographing a meniscus of the ink discharged from the slot die, and
wherein the control unit compares the coating edge of the ink discharged from the slot die, which was photographed by the at least one first camera, with a first reference image, and compares the meniscus of the ink photographed by the at least one second camera with a second reference image, so as to control operation of the slot die.

5. The slot die coating device according to claim 4, wherein the image capture unit further includes a photographing driver for reciprocally driving the at least one first camera along a length direction of the slot die.

6. The slot die coating device according to claim 1,
the slot die coating device further comprising:
a slot die driver connected to the slot die, and driving the slot die to change the position of the slot die; and
an ink supply unit connected to the slot die driver, and supplying the ink to the slot die,
wherein the control unit controls the slot die driver to adjust the position of the slot die according to a result of comparison between the image captured by the image capture unit and the reference image, and controls the ink supply unit to adjust an amount of the ink supplied to the slot die.

7. A control method of a slot die coating device, comprising:
starting a coating process of applying ink to a substrate by a slot die;
capturing images of a state of the slot die and a state of the ink applied to the substrate by an image capture unit during the coating process;
setting a reference image by a control unit on the basis of at least one protrusion formed on a shim plate provided in the slot die; and
controlling operation of the slot die by the control unit according to a result of comparison between the image captured by the image capture unit and the reference image.

8. The control method of a slot die coating device according to claim 7, wherein the process of capturing images of the state of the slot die and the state of the ink applied to the substrate by the image capture unit includes:
photographing a coating edge of the ink discharged from the slot die by at least one first camera disposed on at least one among a front end and a rear end of the slot die along a transfer direction of the substrate; and
photographing a meniscus of the ink discharged from the slot die by at least one second camera disposed on at least one end among both ends of the slot die.

9. The control method of a slot die coating device according to claim 8, wherein the process of controlling the operation of the slot die by the control unit according to a result of comparison between the image captured by the image capture unit and the reference image includes:
comparing the coating edge of the ink discharged from the slot die, which was photographed by the at least one first camera, with a first reference image by the control unit;
comparing the meniscus of the ink, which was photographed by the at least second camera, with a second reference image by the control unit; and
controlling the operation of the slot die by the control unit according to a result of comparison between the coating edge of the ink discharged from the slot die and the first reference image and according to a result of comparison between the meniscus of the ink and the second reference image.

10. The control method of a slot die coating device according to claim 7, wherein the process of controlling the operation of the slot die by the control unit according to a result of comparison between the image captured by the image capture unit and the reference image includes:
controlling a slot die driver changing the position of the slot die to adjust the position of the slot die by the control unit; and
controlling an ink supply unit supplying the ink to the slot die to adjust an amount of the ink supplied to the slot die by the control unit.
